(19) United States
(12) Patent Application Publication
(10) Pub. No.: US 2026/0304180 A1
(43) Pub. Date: Oct. 1, 2026

(54) CODEBLOCK (CB) SORTING AND ACKNOWLEDGEMENT (ACK) REPORT COMPRESSION

(71) Applicant: QUALCOMM Incorporated, San Diego, CA (US)

(72) Inventors: Aviv REGEV, Tel aviv (IL); Ronen SHAKED, Kfar Saba (IL); Gideon Shlomo KUTZ, Ramat Hasharon (IL); Shay LANDIS, Hod Hasharon (IL)

(21) Appl. No.: 19/097,240

(22) Filed: Apr. 1, 2025

(51) Int. Cl. H04W 24/10; H04B 7/06; H04L 25/02

(52) U.S. Cl. CPC H04W 24/10; H04B 7/0632; H04L 25/021

(57) ABSTRACT

A wireless node may include one or more memories, individually or in combination, having instructions. The wireless node may include one or more processors, individually or in combination, configured to execute the instructions and cause the wireless node to: generate a hierarchical ranking of each codeblock group (CBG) of a plurality of CBGs, wherein the hierarchical ranking is based on a first communication metric associated with a channel via which the plurality of CBGs are used to communicate data, obtain data via the plurality of CBGs; and output a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking.

### BACKGROUND

### Technical Field

The present disclosure generally relates to communication systems, and more particularly, to codeblock (CB) sorting and acknowledgement (ACK/NACK) report compression.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure are directed to an apparatus for wireless communication, including one or more memories, individually or in combination, having instructions. The apparatus further includes one or more processors, individually or in combination, configured to execute the instructions. In some examples, the one or more processors are configured to cause the apparatus to generate a hierarchical ranking of each codeblock group (CBG) of a plurality of CBGs, wherein the hierarchical ranking is based on a first communication metric associated with a channel via which the plurality of CBGs are used to communicate data. In some examples, the one or more processors are configured to cause the apparatus to obtain data via the plurality of CBGs. In some examples, the one or more processors are configured to cause the apparatus to output a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking.

Aspects of the disclosure are directed to an apparatus for wireless communication, including one or more memories, individually or in combination, having instructions. The apparatus also includes one or more processors, individually or in combination, configured to execute the instructions. In some examples, the one or more processors are configured to cause the apparatus to generate a hierarchical ranking of each codeblock group (CBG) of a plurality of CBGs, wherein the hierarchical ranking is based on a first communication metric associated with a channel via which the plurality of CBGs are used to communicate data. In some examples, the one or more processors are configured to cause the apparatus to output data for transmission via the plurality of CBGs. In some examples, the one or more processors are configured to cause the apparatus to obtain, from a wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking.

Aspects of the disclosure are directed to a method for wireless communication at a wireless node. In some examples, the method includes generating a hierarchical ranking of each codeblock group (CBG) of a plurality of CBGs, wherein the hierarchical ranking is based on a first communication metric associated with a channel via which the plurality of CBGs are used to communicate data. In some examples, the method includes obtaining data via the plurality of CBGs. In some examples, the method includes outputting a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking.

Aspects of the disclosure are directed to a method for wireless communication at a first wireless node. In some examples, the method includes generating a hierarchical ranking of each codeblock group (CBG) of a plurality of CBGs, wherein the hierarchical ranking is based on a first communication metric associated with a channel via which the plurality of CBGs are used to communicate data. In some examples, the method includes outputting data for transmission via the plurality of CBGs. In some examples, the method includes obtaining, from a second wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking.

Aspects of the disclosure are directed to an apparatus for wireless communication. In some examples, the apparatus includes means for generating a hierarchical ranking of each codeblock group (CBG) of a plurality of CBGs, wherein the hierarchical ranking is based on a first communication metric associated with a channel via which the plurality of CBGs are used to communicate data. In some examples, the apparatus includes means for obtaining data via the plurality of CBGs. In some examples, the apparatus includes means for outputting a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking.

Aspects of the disclosure are directed to an apparatus for wireless communication. In some examples, the apparatus includes means for generating a hierarchical ranking of each codeblock group (CBG) of a plurality of CBGs, wherein the hierarchical ranking is based on a first communication metric associated with a channel via which the plurality of CBGs are used to communicate data. In some examples, the apparatus includes means for outputting data for transmission via the plurality of CBGs. In some examples, the apparatus includes means for obtaining, from a second wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking.

Aspects of the disclosure are directed to a non-transitory computer-readable medium comprising instructions that, when executed by a wireless node, cause the wireless node to perform an operation, including: generating a hierarchical ranking of each codeblock group (CBG) of a plurality of CBGs, wherein the hierarchical ranking is based on a first communication metric associated with a channel via which the plurality of CBGs are used to communicate data. In some examples, the operation includes obtaining data via the plurality of CBGs. In some examples, the operation includes outputting a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking.

Aspects of the disclosure are directed to a non-transitory computer-readable medium comprising instructions that, when executed by a wireless node, cause the wireless node to perform an operation, including: generating a hierarchical ranking of each codeblock group (CBG) of a plurality of CBGs, wherein the hierarchical ranking is based on a first communication metric associated with a channel via which the plurality of CBGs are used to communicate data. In some examples, the operation includes outputting data for transmission via the plurality of CBGs. In some examples, the operation includes obtaining, from a second wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example structure of a transport block (TB).

FIG. 6 is a call-flow diagram illustrating example communications between a network entity and a UE.

FIG. 7 is a flowchart of a method of wireless communication.

FIG. 8 is a flowchart of a method of wireless communication.

FIG. 9 is a diagram illustrating an example of a hardware implementation for an example apparatus.

FIG. 10 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

One of the main challenges in the ever-evolving wireless communication standards is developing an efficient way to retransmit data when decoding fails. Traditionally, as seen in LTE, a wireless node may transmit an acknowledgment (ACK) or negative acknowledgment (NACK) signal in response to each transport block (TB) it receives or is meant to receive. If the wireless node fails to receive or decode even a portion of the data or information transmitted via a TB, then the wireless node will transmit a NACK, resulting in the entire TB would being retransmitted, including data or information that was successfully received and decoded. However, because TB are growing in size with the ever-evolving wireless communication standards, this traditional mode of ACK/NACK communication is correspondingly growing more inefficient. In other words, because TBs are larger, a NACK transmission may require retransmission of a significant amount of unnecessary data. This affects resource efficiency, latency, and throughput of wireless communication.

As seen in 5G, ACK/NACK communications have evolved such that ACK/NACK signals are transmitted for codeblocks (CB) known as code block groups (CBGs), which are smaller than TBs. This allows for the transmitting device to retransmit only the specific CBGs that failed, rather than the entire TB, thereby saving resources and improving the speed of communications. However, similar to the issues described above in reference to TBs, if even one CB in a CBG fails, then all CBs in that group are retransmitted in response to a NACK, even those that were successfully decoded from the original transmission. Moreover, the 5G approach requires that an ACK/NACK signal be transmitted for each CBG, resulting in a substantial increase in uplink overhead (e.g., which adds up to one bit per CBG). This increased overhead limits the number of CBGs that can be managed, especially as more and different control signals are being added to uplink control transmissions as a result of standards evolution.

Moreover, as evolving wireless communication standards employ high-rate link adaptation, such as tight link adaptation using multiple input rates (MIRs), having ACK/NACK signals for small groups of code blocks, even down to a single block, becomes more important. Thus, the aspects of the disclosure are directed to reducing the number of bits needed for ACK/NACK signaling. Aspects of the disclosure are directed to compressed reports that, in one example, may use the same uplink overhead for 1024 CBGs as a traditional report would use for 10 CBGs. Similarly, a compressed report for 8 CBGs would require only 3 bits instead of 8. Moreover, the compression described herein is designed to have reduced impact on performance, by ensuring that even if the compressed report is incorrectly decoded, the retransmission of unnecessary data blocks (e.g., data blocks already correctly received and decoded) is minimized.

Additionally, the compression methods described herein are further designed to prevent scenarios where a failed code block could be mistakenly reported as successfully decoded (ACK), thus avoiding false alarms. While it allows for missed detections where a successful decoding might be reported as a failure (NACK), it ensures that no false acknowledgments occur.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

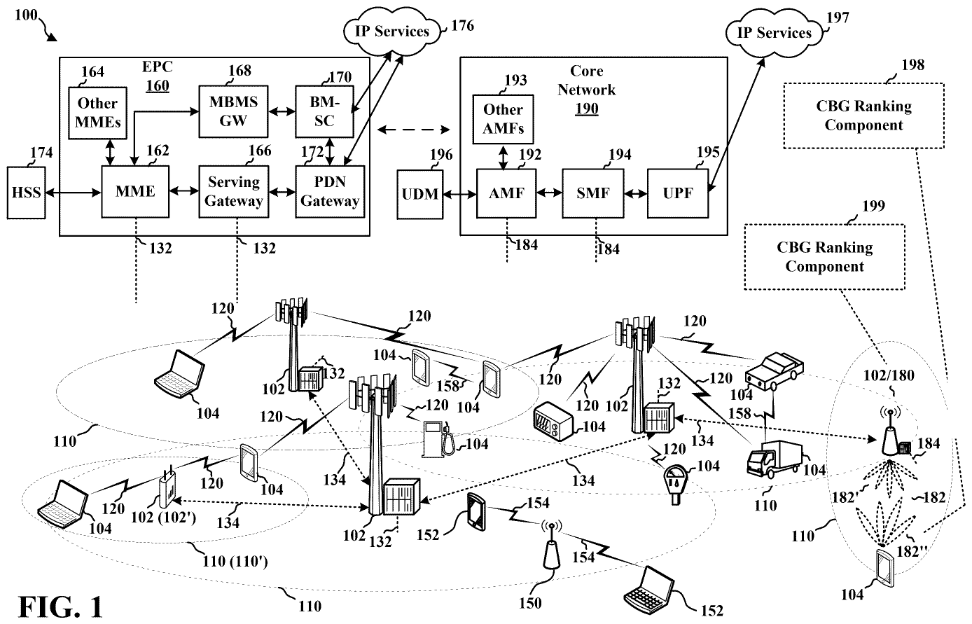

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a CBG ranking component 198. As described in more detail elsewhere herein, the CBG ranking component 198 may be configured to: generate a hierarchical ranking of each codeblock group (CBG) of a plurality of CBGs, wherein the hierarchical ranking is based on a first communication metric associated with a channel via which the plurality of CBGs are used to communicate data; obtain data via the plurality of CBGs; and output a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking. Additionally, or alternatively, the CBG ranking component 198 may perform one or more other operations described herein.

The base station 102/180 may include a CBG ranking component 199. As described in more detail elsewhere herein, the CBG ranking component 199 may be configured to: generate a hierarchical ranking of each codeblock group (CBG) of a plurality of CBGs, wherein the hierarchical ranking is based on a first communication metric associated with a channel via which the plurality of CBGs are used to communicate data; output data for transmission via the plurality of CBGs; and obtain, from a wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking. Additionally, or alternatively, the CBG ranking component 199 may perform one or more other operations described herein.

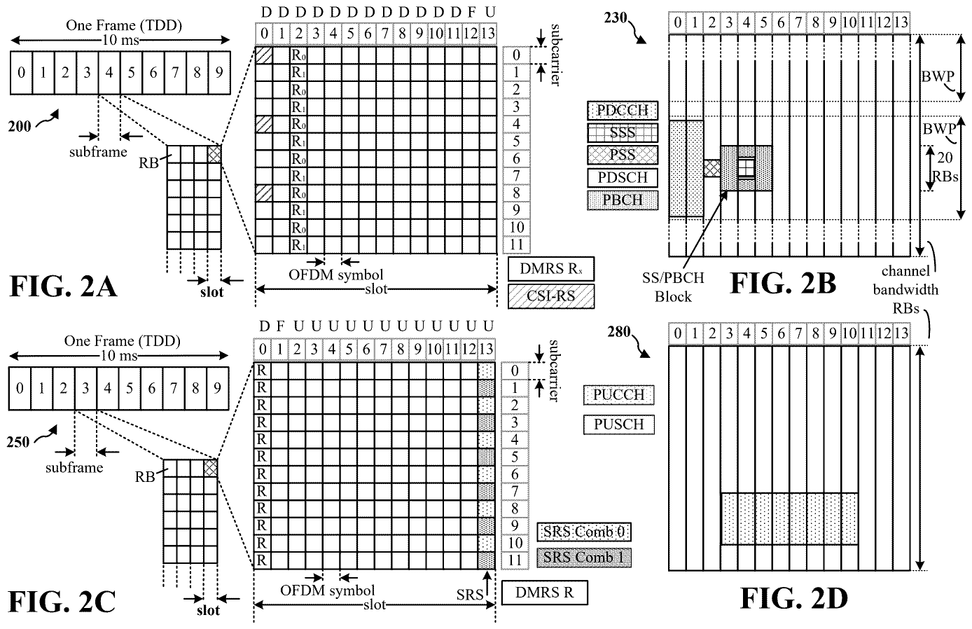

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology u=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

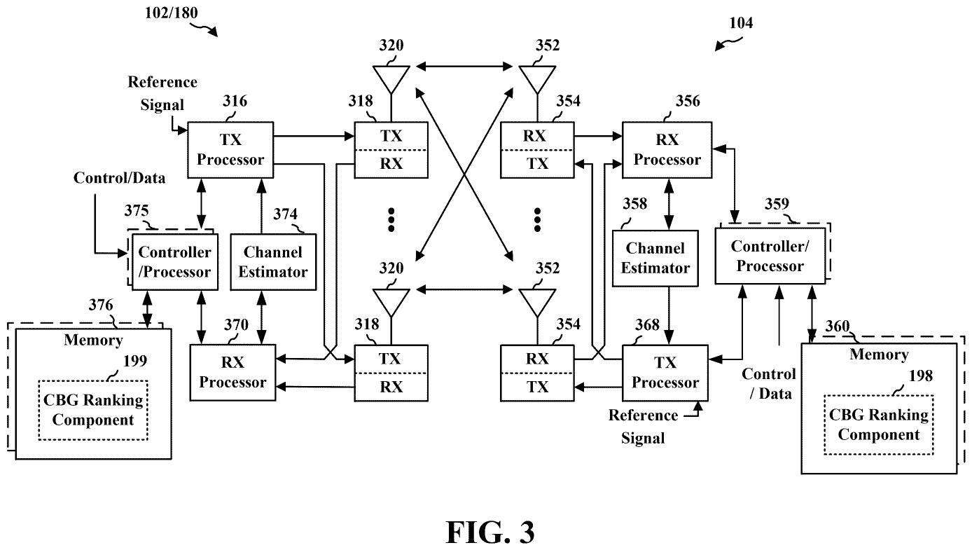

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

As used herein, a “reference signal” relates to a predefined signal transmitted by the base station (gNB) or the user equipment (UE) that does not carry data itself, but is used for various purposes like channel estimation, demodulation, synchronization, phase-noise compensation, and/or tracking. That is, reference signals may function as a guide for a receiver to properly interpret and process actual data signals that it receives. Wireless communication systems may include a variety of reference signal types, such as: CSI-RS, SRS, phase tracking reference signal (PTRS), DM-RS, a cell-specific reference signal (CRS), and/or synchronization signals (e.g., a primary synchronization signal (PSS) or a secondary synchronization signal (SSS)) and the like.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

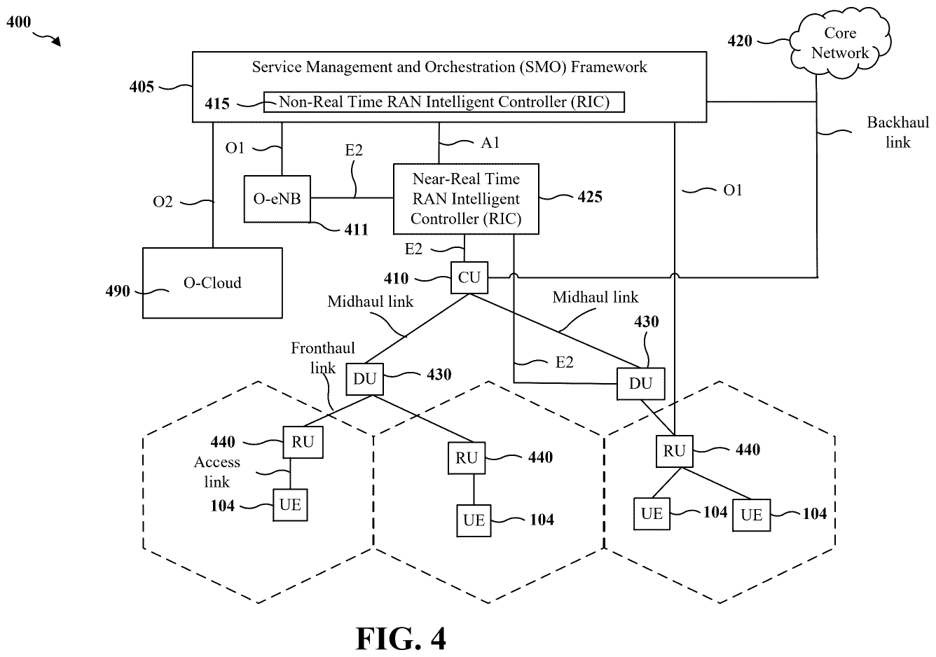

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of Compressed ACK/NACK Reporting

Aspects of the disclosure are directed to techniques for ACK/NACK reporting using a format that is compressed (e.g., uses less uplink overhead) relative to current 5G and LTE implementations. These techniques allow for an increase in the quantity of CBGs in a TB and reduce the amount of downlink transmissions of CBs that were already successfully decoded.

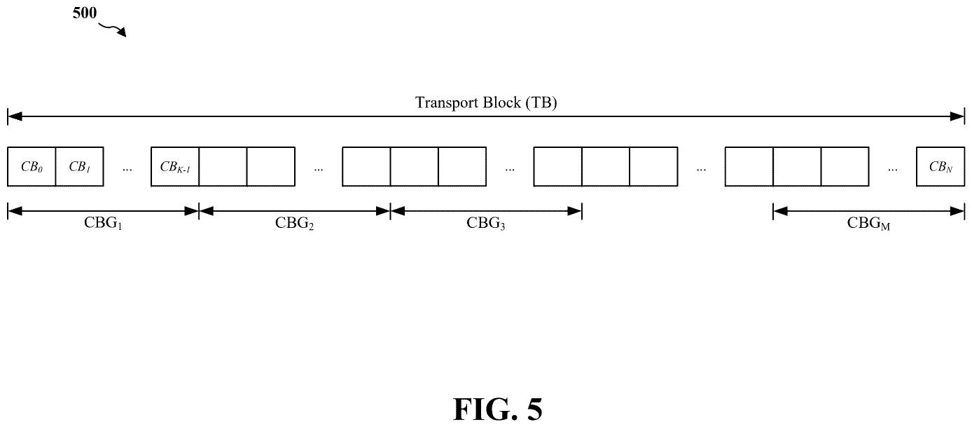

FIG. 5 is a block diagram illustrating an example structure of a transport block (TB) 500. In some examples, a TB relates to a fundamental unit of data used in wireless communication systems, and it represents an organization of data transmitted via a wireless interface from one wireless node to another (e.g., from a network entity to a user equipment (UE) or vice versa). A TB may vary in size depending on the network conditions and the capabilities of the devices involved. In a transmission process, the TB 500 is encoded and modulated to ensure reliable delivery over the air interface, and it is subject to error correction techniques to handle any potential data loss or corruption during transmission.

Within the TB, data is further divided into smaller units called code blocks (CBs). These code blocks are the result of segmenting the TB into manageable pieces that can be individually processed for error correction. The segmentation into CBs allows for more efficient error detection and correction, as each CB can be independently checked and retransmitted if necessary. This segmentation aids in maintaining data integrity, particularly in environments with high error rates.

Code block groups (CBGs) are collections of CBs within the TB 500. As discussed, the concept of CBGs is particularly relevant in 5G, where the acknowledgment (ACK) or negative acknowledgment (NACK) feedback is provided at the CBG level rather than for the entire TB. Thus, if a decoding error occurs, only the specific CBGs that contain the erroneous CBs need to be retransmitted, rather than the entire TB. As illustrated, the TB 500 is comprised of M CBGs for a total of N CBs, with each of the M CBGs comprising K−1 CBs.

The number of CBs within a CBG can vary depending on the specific configuration and the size of the TB being transmitted. In some examples, the segmentation of TBs into CBs and the grouping of these CBs into CBGs is flexible and can be adjusted based on network conditions, channel quality, and other factors.

The number of CBs within a TB can vary rather significantly depending on several factors, including the size of the TB, the MCS used, and/or the specific configuration of the network. In general, the segmentation of a TB into CBGs may be determined by the maximum CB size, which may be set by communication standards to ensure efficient error correction and processing.

In a wireless communication system, the network entity 102 may determine how many code block groups (CBGs) will be used in communication with a UE 104. The network entity 102 and the UE 104 may further determine to use a compressed acknowledgment (ACK) or negative acknowledgment (NACK) report. Although a CBG typically contains multiple code blocks (CBs), the compressed ACK/NACK report as described herein may allow the UE 104 and network entity 102 to use just one CB per CBG, meaning the UE 104 can report ACK/NACK for each individual CB. Although this setup results in a large number of CBGs, the uplink overhead associated with the ACK/NACK report will not exceed the current limits of wireless standards. For example, with 128 CBs, a compressed ACK/NACK report would only require 7 bits (e.g., log₂ (128)).

Signal quality associated with different CBs and/or CBGs within a transport block (TB) can vary significantly. As such, they may not all have the same likelihood of successful transmission. Such variation in signal quality may become more pronounced in channels with high dispersion. For example, a CB allocated to a frequency region with fading or interference might experience poor channel conditions, while another CB in a stable, interference-free region may experience relatively good conditions. Therefore, the probability of successful transmission is higher for the latter CB.

In certain aspects, both the network entity 102 and the UE 104 may measure and rank the quality of each CBG's channel in advance, using knowledge of the channel. Various communication metrics can be used to assess channel quality, such as signal-to-noise ratio (SNR), received signal strength indicator (RSSI), reference signal received power (RSRP), reference signal received quality (RSRQ), channel capacity, and/or mutual information. One example metric is a sum or average of the capacities of REs within each CB of a CBG, calculated using Teletar's formula:

$$Metric 1 ( {CBG}_{j} ) = {C}_{{CBG}_{j}} = {\sum }_{CBi ∈ {CBG}_{j}} {\sum }_{k ∈ {CB}_{i}} {log}_{2} \vert {I}_{NssxNss} + {H}_{k}^{H} {R}_{nn}^{- 1} {H}_{k} \vert \qquad Equation 1$$

Where C_{CBG}_{ⱼ} relates to a channel capacity and/or quality of the j^{th} CBG; I is an identity matrix; Nₛₛ is a number representing a quantity of transmitted streams; Rₙₙ is an autocovariance matrix associated with downlink noise; Hₖ is a channel at the k^{th} RE known at both the UE 104 and the network entity 102. Thus, the expression shown in Equation 1 is simply summing the capacities at all the REs that belong to a particular CB. Because Rₙₙ is used to calculate the exemplified metric, and because the exemplified metric may be calculated by both the UE 104 and the network entity 102, both devices should have knowledge of the Rₙₙ. Thus, in some examples, the UE 104 may transmit an indication of Rₙₙ to the network entity 102 periodically and/or upon request.

Another example metric may include evaluating each CBG to identify which CB within each CBG has a lowest capacity and/or quality within it (relative to other CBs within the same CBG), using the following expression:

$$\begin{matrix}Metric 2 ( {CBG}_{j} ) = {min}_{i} ( {\sum }_{k ∈ {CB}_{i}} {log}_{2} \vert {I}_{NssxNss} + {H}_{k}^{H} {R}_{nn}^{- 1} {H}_{k} \vert ) \\ CBi ∈ {CBG}_{j}\end{matrix} \qquad Equation 2$$

Thus, for each CBG, the UE 104 and the network entity 102 may determine the CB that has the lowest capacity (e.g., indicates the poorest channel condition) value in each CBG. Once the lowest capacity value associated with each CBG is known, the CBGs may be sorted according to the capacity values (e.g., from lowest capacity value to the highest capacity value).

For example, if the UE 104 and the network entity 102 communicate via a TB consisting of eight CBGs, the UE 104 and the network entity 102 would end up with eight capacity values, one for each CBG, with each capacity value representing the worst-performing CB in each CBG. TABLE 1 below is an example of how CBGs may be sorted according to a lowest capacity CB value from within each CBG. This sorting helps prioritize which CBGs might need more attention or retransmission efforts (e.g., the transmission is not received by a UE 104, or the UE 104 is unable to properly decode the transmission), as those with lower quality/capacity values are more likely to experience transmission issues.

TABLE 1

| | Value of the | Sorted CBG | |
|---|---|---|---|
| CBG Indices | Chosen Metric | Indices | Sorted Values |
| 1 | 24.8 | 6 | 25.9 |
| 2 | 24.4 | 8 | 25.7 |
| 3 | 24.2 | 5 | 25.6 |
| 4 | 23 | 7 | 25.5 |
| 5 | 25.6 | 3 | 25.2 |
| 6 | 25.9 | 1 | 24.8 |
| 7 | 25.5 | 2 | 24.4 |
| 8 | 25.7 | 4 | 23 |

Here, a TB is divided into 8 CBGs, with each CBG identifiable by an index. The first column of TABLE 1 relates to “CBG indices,” and includes eight CBG indices. For example, a TB may include eight CBGs identifiable by indices 1-8. The second column relates to a “value of the chosen metric.” Here, using any suitable metric, the lowest capacity value associated with each CBG is calculated and stored in a memory with a mapping to the corresponding CBG index of the first column. The third column relates to “sorted CBG indices” and the fourth column relates to “sorted values.” As described above, the fourth column represents values of the chosen metric sorted from lowest capacity value to the highest capacity value, and the third column represents the CBG indices sorted according to the corresponding chosen metric value.

The compressed ACK/NACK report is configured to indicate an index of the first CBG that failed. For example, the UE 104 may determine that one or more CBs of a first CBG were not received or did not decode properly, and therefore, need to be retransmitted. The UE 104 may then generate the compressed ACK/NACK report indicating the index associated with the first CBG and transmit the compressed ACK/NACK report to the network entity 102. Once the network entity 102 receives this index, it may infer that all CBGs ranked lower than this index have also failed and need to be retransmitted.

For example, referring to TABLE 1 above, if the network entity 102 transmits signaling to the UE 104 using CBGs having indices 1-8, but CBG indices 2 and 4 failed during decoding, the traditional report would require 8 bits to indicate success or failure, with each bit representing a CBG individually. Thus, the resulting report may provide the following information: [1,0,1,0,1,1,1,1], where ‘l’ represents ACK and ‘0’ represents NACK. In contrast, the compressed ACK/NACK report would simply indicate the index of the first failed CBG according to the sorted CBG indices of the third column (e.g., CBG index 2, in this case), using a format such as: (e.g., binary for 2). Accordingly, the network entity 102 may conclude that because CBG index 2 is indicated in the compressed ACK/NACK report, and because CBG index 4 is ranked lower than CBG index 2, that data transmitted via both of CBG indices 2 and 4 needs to be retransmitted. Note however, that the compressed ACK/NACK report uses only 3 bits instead of 8, achieving a 63% reduction in uplink overhead, relative to traditional ACK/NACK reporting.

This compression saves bandwidth and improves the efficiency of the communication process. Moreover, because the network entity 102 may assume that CBGs ranked lower than the CBG identified by the compressed ACK/NACK report also need to be retransmitted, this eliminates the possibility of an ACK-to-NACK (A2N) error.

Aspects of the disclosure are directed to managing mismatches between UE 104 and network entity 102 CBG rankings (e.g., ensuring that the tables generated by the UE and network entity are matching). For example, each of the UE 104 and the network entity 102 may rely on a common knowledge of channel conditions to generate respective tables, which is necessary for proper use of the compressed ACK/NACK report because the ranking of CBGs depends on these channel conditions, and the compressed ACK/NACK report depends on both the UE 104 and the network entity 102 having the same ranking due to channel reciprocity or reporting. In other words, differences in how each side perceives the channel can lead to different CBG rankings, potentially causing discrepancies in decisions made by the network entity 102 and UE 104.

Thus, in certain aspects, the UE 104 may transmit a redundancy check (e.g., CRC bits) to the network entity 102 whenever there is a change in the CBG partitioning due to channel variations, to ensure both sides generate consistent tables. In one example, the UE 104 may generate a CBG ranking table (e.g., see example TABLE 1) and input the ranked/sorted CBGs indices into a CRC calculator to generate the CRC bits. In other words, the UE 104 may transmit an indication of the ranked/sorted CBGs indices (e.g., the third column of TABLE 1, “sorted CBG indices”) to the network entity 102 via CRC bits. The network entity 102 may then performs the same CRC calculation using the sorted CBG indices of its own generated table and compare the results with the CRC bits received from the UE 104. If there is a mismatch, the network entity 102 may transmit a notification to the UE 104 to inform it of the mismatch, and to revert to legacy ACK/NACK reporting as defined by the current standard.

In certain aspects, to further reduce the likelihood of ranking mismatches between the UE 104 and the network entity 102, the network entity 102 and the UE 104 may periodically (re-)evaluate and (if necessary) update the channel conditions and corresponding CBG partitioning. In some examples, such an evaluation may occur periodically (e.g., every X number of slots, where X is a non-zero integer) based on a predefined schedule configured at the UE 104 via signaling form the network entity 102. For example, the network entity 102 may transmit an indication of a slot number used for channel evaluation and an indication of the update frequency to the UE 104 to ensure that both sides assess the channel conditions at the same time and frequency. This approach helps maintain consistency in CBG rankings by ensuring both the network entity 102 and the UE 104 rely on the same channel data. Moreover, this synchronization minimizes the risk of mismatches between the two devices.

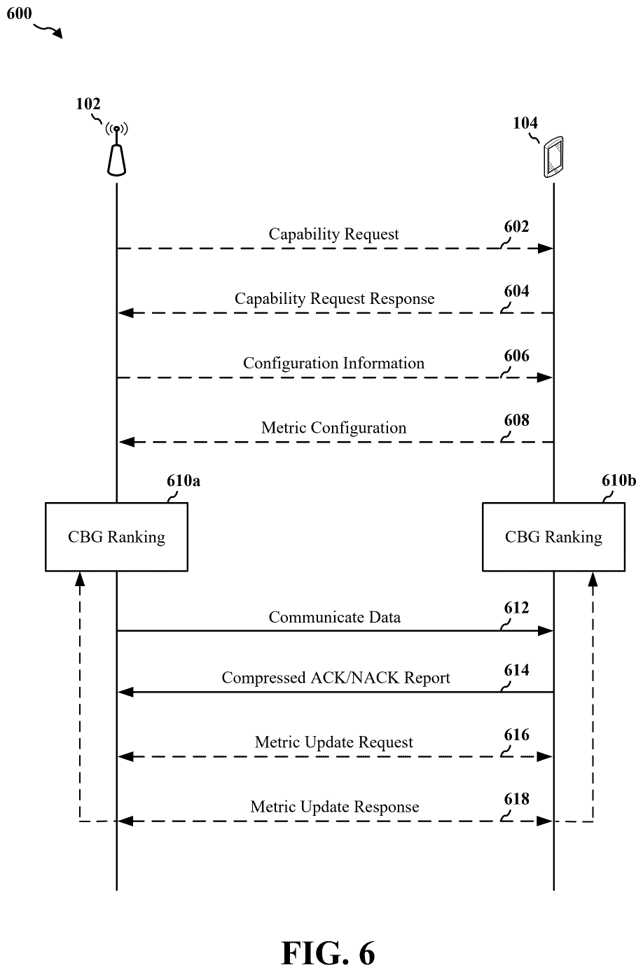

FIG. 6 is a call-flow diagram illustrating example communications 600 between a network entity 102 and a user equipment (UE) 104. In this illustration, time advances in the downward direction, and communication signals between the illustrated entities are denoted with arrows between the lines below the respective entities. Dashed lines indicate optional communication signals.

At a first communication 602, the network entity 102 may transmit a capability request to the UE 104. The first communication 602 may be made via RRC configuration messaging, MAC-CE, or DCI. For example, the network entity 102 may transmit the request to the UE 104 via a downlink channel, wherein the request is configured to cause the UE 104 to transmit an indication of its capability to send a compressed ACK/NACK report. In some examples, the first communication 602 may include an indication of one or more possible metrics (e.g., equations above, and/or signal measurements used) that the network entity 102 may use for sorting CBGs according to ranking (e.g., as shown in TABLE 1 above).

In certain aspects, the compressed ACK/NACK report relates to a report that includes log₂ N bits instead of N bits, where N is a non-zero integer indicative of the number of CBGs via which the UE 104 and network entity 102 communicate. This reduction in the quantity of bits required to convey an ACK/NACK indication allows the network entity 102 to increase the quantity of CBGs used for communications and reduce the bit overhead associated with an ACK/NACK report. For example, a 1024 CBG ACK/NACK compressed report may consume the same uplink bit overhead as a 10 CBG legacy (e.g., LTE) report. This reduction in the quantity of bits required to convey an ACK/NACK indication also reduces the ACK/NACK UL overhead: for example, an 8 CBGs compressed report will consist of 3 information bits instead of 8.

At a second communication 604, the UE 104 may respond to the capability request of the first communication 602. For example, the UE 104 may transmit signaling indicative of whether it has the capability to transmit compressed ACK/NACK reports. In some examples, the UE 104 may provide an indication of one or more possible metrics (e.g., equations above, and/or signal measurements used) that the UE 104 is capable of using for sorting CBGs according to ranking (e.g., as shown in TABLE 1 above). In one example, if the first communication 602 included one or more possible metrics, then the UE 104 may indicates which of the possible metrics it can use for CBG ranking. The second communication 604 may be transmitted via RRC, MAC-CE, or UCI.

At a third communication 606, the network entity 102 may transmit configuration information for compressed ACK/NACK reporting. In some examples, the configuration information may be transmitted in response to an affirmative capability indication received via the second communication 604. In other examples, the configuration information may be transmitted to the UE 104 without any prior indication of the UE's capability for compressed ACK/NACK reporting.

In certain aspects, the network entity 102 may transmit an indication of a new number of CBGs to be used for future communications between the UE 104 and the network entity 102. Because the compressed ACK/NACK report requires less bits to report ACK/NACK for a greater quantity of CBGs, the network entity 102 may increase the number of CBGs used for communication.

In some examples, the network entity 102 may indicate one or more metrics (e.g., metrics that both sides can perform to determine values in the fourth column of TABLE 1) to be used to generate CBG rankings. In some examples, the network entity 102 may indicate a particular one or more slots or a window of time for which signaling may be measured and used for ranking the CBGs. In other words, the network entity 102 may provide the UE 104 with an indication of slots during which signaling should be measured, so that the UE 104 knows when to start and end signal measurement for CBG ranking.

At a fourth communication 608, the UE 104 may transmit a metric configuration to the network entity 102. Here, UE 104 may transmit additional information for calculation of the chosen metric or using the chosen metric. For example, the UE may transmit an autocovariance noise matrix (Rₙₙ) associated with the channel via which the CBGs are used to communicate. In some examples, this additional information may be transmitted via an uplink control channel (e.g., PUCCH as part of the UCI).

At a pair of processes 610 (individually numbered as a first process 610a performed by the network entity 102, and a second process 610b performed by the UE 104), the UE 104 and the network entity 102 may measure signaling received via the CBGs, and may determine a measured value associated with each CBG. The measured value may indicate a quality associated with each CBG. The UE 104 and network entity 102 may then sort the CBGs according to the corresponding quality rankings.

At a fifth communication 612, the network entity 102 may transmit data to the UE 104. Here, the UE 104 may receive the data and determine whether to report an ACK or a NACK for any of the CBGs. For example, if data is not received via a particular CBG or a CB of the CBG, or if the UE 104 is unable to properly decode data it received via the CBG, then the UE 104 may determine to transmit a NACK associated with that CBG.

Thus, at a sixth communication 614, the UE 104 may transmit a compressed ACK/NACK report to the network entity 102. Referring back to TABLE 1 above, if the UE 104 does not receive data via the CBGs associated with index 1, 2 and 4, then the UE 104 may generate a compressed ACK/NACK report identifying CBG index 1 and without identifying any other indices. This is because the compressed ACK/NACK report is configured to explicitly indicate one CBG for which a NACK is reported, while implicitly indicating all CBGs ranked lower than the explicitly indicate CBG. In other words, the UE 104 needs to transmit a NACK for CBGs associated with index 1, 2 and 4, so that the network entity 102 will retransmit the data. Because the CBGs having indices 2 and 4 are ranked lower than 1, the network entity 102 may assume that the compressed ACK/NACK report is reporting a NACK for the CBGs associated with index 1, 2 and 4 despite the report only explicitly indicating index 1.

At a seventh communication 616, either (or both) of the UE 104 and network entity 102 may request to update the CBG ranking (e.g., due to channel aging, SNR changing, mobility, configuration changing, interference or blocking scenarios, etc.). In some examples, the request may be aperiodic or perioding, based on to network entity 102 and/or UE 104 policy. In some examples, the request may indicate that the transmitting entity has determined to stop the compressed ACK/NACK reporting procedure and fallback to a legacy approach to ACK/NACK reporting.

At an eighth communication 618, the receiving entity approves/disapproves the request of the previous communication. If approved, one or more of: the network entity 102 may transmit the configuration information described above at the third communication 606, the UE 104 may transmit the configuration information of the fourth communication 608, and the UE 104 and network entity 102 may perform the pair of processes 610.

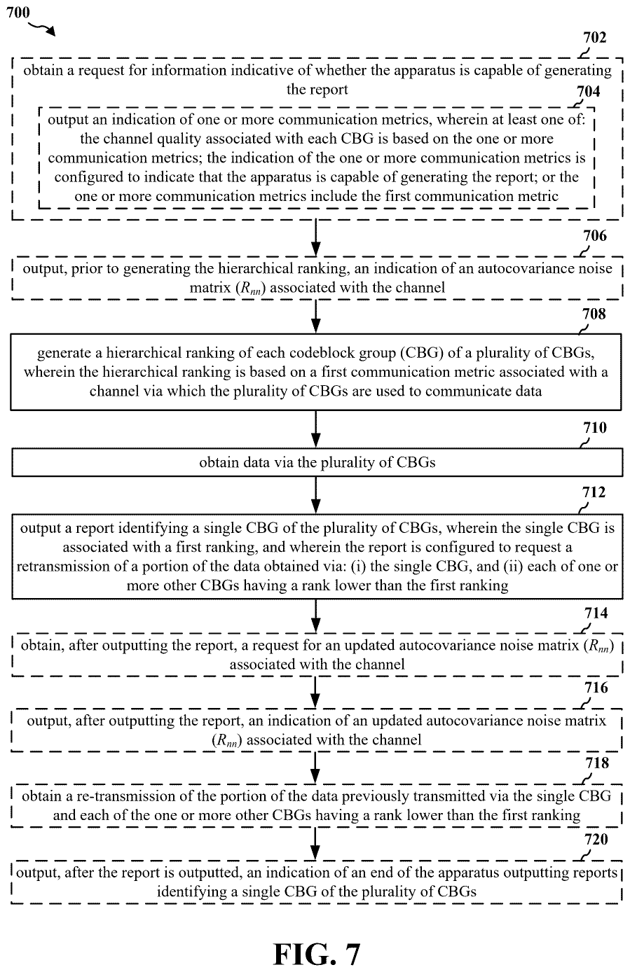

FIG. 7 is a flowchart 700 of a method of wireless communication. The method may be performed by a UE (e.g., the UE 104; the apparatus 802). Specifically, the method may be performed by one or more memories, processors, and RF front ends (e.g., the memory 360, controller/processor 359, transmitter 354TX, receiver 354RX, antenna 352, etc. of FIG. 3).

At 702, the UE may obtain a request for information indicative of whether the apparatus is capable of generating the report. For example, 702 may be performed by an obtaining component 840. For example, the request for information may be transmitted by the network entity 102 in the first communication 602 illustrated in FIG. 6.

At 704, the UE may output an indication of one or more communication metrics, wherein at least one of: the channel quality associated with each CBG is based on the one or more communication metrics; the indication of the one or more communication metrics is configured to indicate that the apparatus is capable of generating the report; or the one or more communication metrics include the first communication metric. For example, 704 may be performed by an outputting component 842. Here, the UE may transmit an indication of its capability to generate and transmit compressed ACK/NACK reports as illustrated in the second communication 604 of FIG. 6, and/or an indication of a metric configuration as illustrated in the fourth communication 608 of FIG. 6.

At 706, the UE may output, prior to generating the hierarchical ranking, an indication of an autocovariance noise matrix (Rₙₙ) associated with the channel. For example, 706 may be performed by the outputting component 842. Here, the UE may transmit an indication of the autocovariance noise matrix to the network entity 102 so that when the UE and the network entity generate and sort the CBG table (e.g., TABLE 1), they are each able to generate tables that rank the CBGs in the same order.

At 708, the UE may generate a hierarchical ranking of each codeblock group (CBG) of a plurality of CBGs, wherein the hierarchical ranking is based on a first communication metric associated with a channel via which the plurality of CBGs are used to communicate data. For example, 708 may be performed by generating component 844. Here, the UE may measure signaling it receives via each CBG, and rank the CBGs according to the quality/capacity of the measured signaling, as illustrated in the second process 610b of FIG. 6.

At 710, the UE may obtain data via the plurality of CBGs. For example, 710 may be performed by the obtaining component 840. Here, the UE 104 may receive data transmitted by the network entity 102 via the plurality of CBGs, as illustrated in the fifth communication 612 of FIG. 6.

At 712, the UE may output a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking. For example, 712 may be performed by the outputting component 842. Here, the UE may generate a compressed ACK/NACK report configured to indicate a single CBG (e.g., via an index associated with that CBG) as illustrated in the sixth communication 614 of FIG. 6. For example, if the report indicates that data transmitted via a first CBG was not received or decoded, the report may indicate an index associated with the first CBG. The report is further configured to implicitly indicate that data transmitted via all CBGs ranked lower than the first CBG should also be retransmitted.

At 714, the UE may obtain, after outputting the report, a request for an updated autocovariance noise matrix (Rₙₙ) associated with the channel. For example, 714 may be performed by the obtaining component 840. Here, the UE 104 may request that the network entity 102 update its metric for measuring CBGs and generating CBG rankings. For example, the UE 104 may request the update, as illustrated by the seventh communication 616 of FIG. 6.

At 716, the UE may output, after outputting the report, an indication of an updated autocovariance noise matrix (Rₙₙ) associated with the channel. For example, 716 may be performed by an outputting component 842. Here, the UE may transmit an indication of an updated channel parameter to the network entity 102 so that the CBG ranking can be modified as the channel changes.

At 718, the UE may obtain a re-transmission of the portion of the data previously transmitted via the single CBG and each of the one or more other CBGs having a rank lower than the first ranking. For example, 718 may be performed by the obtaining component 840. Here, the UE may receive a retransmission of data that was NACK′d via the compressed ACK/NACK report. The retransmitted data may be retransmitted via the same CBGs as the original transmission, or the data may be retransmitted via higher ranked CBGs different from the original transmission.

Finally, at 720, the UE may output, after the report is outputted, an indication of an end of the apparatus outputting reports identifying a single CBG of the plurality of CBGs. For example, 720 may be performed by an outputting component 842. Here, the UE 104 may transmit an indication that it will no longer support compressed ACK/NACK reporting, and will use legacy (e.g., according to current standards) ACK/NACK reporting.

In certain aspects, at least one of: the hierarchical ranking of each CBG is based on a channel quality of each CBG relative to channel qualities of other CBGs of the plurality of CBGs; or the channel quality of each CBG is based on the first communication metric.

In certain aspects, at least one of: the hierarchical ranking of each CBG is further based on a capacity associated with each codeblock (CB) within a given CBG; or the capacity is based on at least one of the channel quality associated with the channel or an autocovariance noise matrix (Rₙₙ) associated with the channel.

In certain aspects, at least one of: the indication of the autocovariance noise matrix (Rₙₙ) is output for transmission via a control channel, or the one or more processors, individually or in combination, are further configured to cause the apparatus to obtain, after outputting the report, a request for an updated autocovariance noise matrix (Rₙₙ) associated with the channel.

In certain aspects, the indication of the updated autocovariance noise matrix (Rₙₙ) is output for transmission on a periodic basis or a semi-persistent basis.

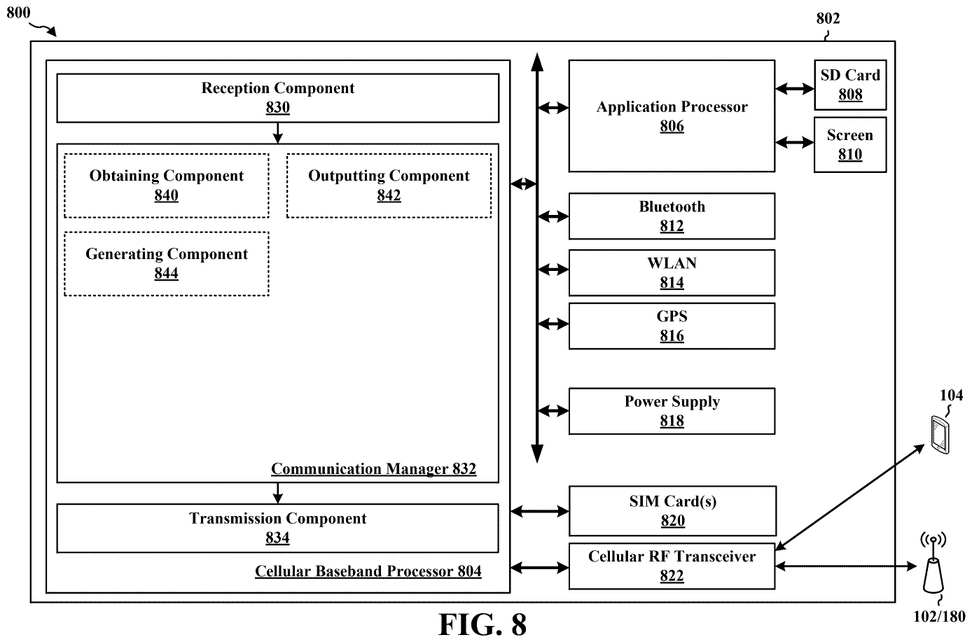

FIG. 8 is a diagram 800 illustrating an example of a hardware implementation for an apparatus 802. The apparatus 802 is a UE and includes a cellular baseband processor 804 (also referred to as a modem) coupled to one or more cellular RF transceivers 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the one or more cellular RF transceivers 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 104 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see UE 104 of FIG. 3) and include the aforediscussed additional modules of the apparatus 802.

In various examples, the apparatus 802 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 832 includes an obtaining component 840 that is configured to: obtain a request for information indicative of whether the apparatus is capable of generating the report; obtain data via the plurality of CBGs; obtain, after outputting the report, a request for an updated autocovariance noise matrix (Rₙₙ) associated with the channel; and obtain a re-transmission of the portion of the data previously transmitted via the single CBG and each of the one or more other CBGs having a rank lower than the first ranking; e.g., as described in connection with 702, 710, 714, and 718.

The communication manager 832 further includes an outputting component 842 configured to: output an indication of one or more communication metrics, wherein at least one of: the channel quality associated with each CBG is based on the one or more communication metrics; the indication of the one or more communication metrics is configured to indicate that the apparatus is capable of generating the report; or the one or more communication metrics include the first communication metric; output, prior to generating the hierarchical ranking, an indication of an autocovariance noise matrix (Rₙₙ) associated with the channel; output a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking; output, after outputting the report, an indication of an updated autocovariance noise matrix (Rₙₙ) associated with the channel; and output, after the report is outputted, an indication of an end of the apparatus outputting reports identifying a single CBG of the plurality of CBGs; e.g., as described in connection with 704, 706, 712, 716, and 720.

The communication manager 832 further includes a generating component 844 configured to generate a hierarchical ranking of each codeblock group (CBG) of a plurality of CBGs, wherein the hierarchical ranking is based on a first communication metric associated with a channel via which the plurality of CBGs are used to communicate data, e.g., as described in connection with 708.

The apparatus may include additional components that perform each of the blocks of the algorithm in the aforementioned call-flow diagram of FIG. 6 and the flowchart of FIG. 7. As such, each block in the aforementioned figures may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes: means for obtaining a request for information indicative of whether the apparatus is capable of generating the report; means for outputting an indication of one or more communication metrics, wherein at least one of: the channel quality associated with each CBG is based on the one or more communication metrics, the indication of the one or more communication metrics is configured to indicate that the apparatus is capable of generating the report, or the one or more communication metrics include the first communication metric; means for outputting, prior to generating the hierarchical ranking, an indication of an autocovariance noise matrix (Rnn) associated with the channel; means for generating a hierarchical ranking of each codeblock group (CBG) of a plurality of CBGs, wherein the hierarchical ranking is based on a first communication metric associated with a channel via which the plurality of CBGs are used to communicate data; means for obtaining data via the plurality of CBGs; means for outputting a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking; means for obtaining, after outputting the report, a request for an updated autocovariance noise matrix (Rnn) associated with the channel; means for outputting, after outputting the report, an indication of an updated autocovariance noise matrix (Rnn) associated with the channel; means for obtaining a re-transmission of the portion of the data previously transmitted via the single CBG and each of the one or more other CBGs having a rank lower than the first ranking; and means for outputting, after the report is outputted, an indication of an end of the apparatus outputting reports identifying a single CBG of the plurality of CBGs.

The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for determining, means for selecting, means for calculating, and means for generating may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

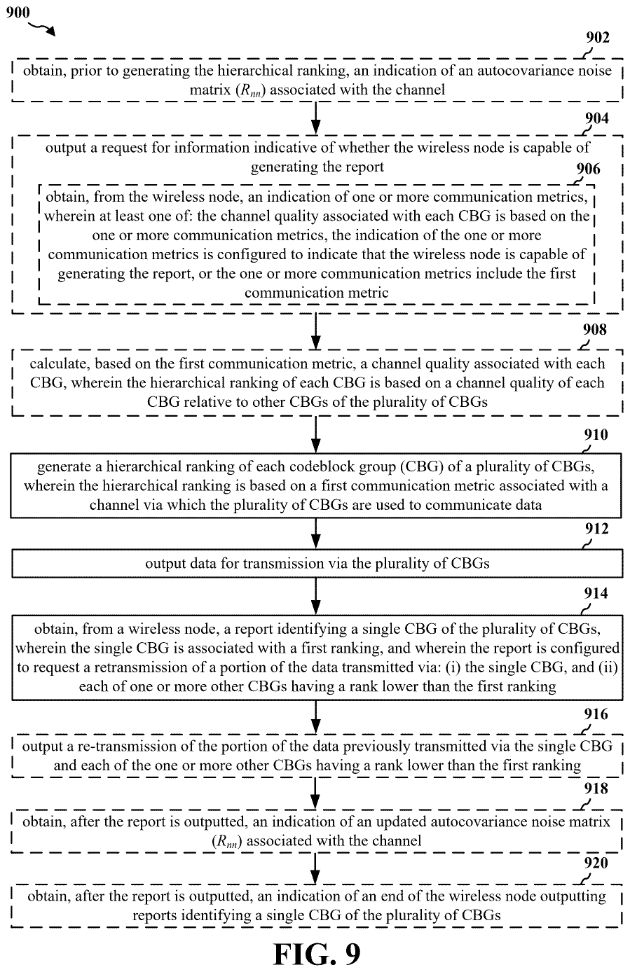

FIG. 9 is a flowchart 900 of a method of wireless communication. The method may be performed by a network entity or base station (e.g., the base station 102/180; the apparatus 1002). Specifically, the method may be performed by one or more memories, processors, and RF front ends (e.g., the memory 376, controller/processor 375, transmitter 318TX, receiver 318RX, antenna 320, etc. of FIG. 3).

At 902, the network entity may obtain, prior to generating the hierarchical ranking, an indication of an autocovariance noise matrix (Rₙₙ) associated with the channel. For example, 902 may be performed by an obtaining component 1040.

At 904, the network entity may output a request for information indicative of whether the wireless node is capable of generating the report. For example, 904 may be performed by an outputting component 1042.

At 906, the network entity may obtain, from the wireless node, an indication of one or more communication metrics, wherein at least one of: the channel quality associated with each CBG is based on the one or more communication metrics, the indication of the one or more communication metrics is configured to indicate that the wireless node is capable of generating the report, or the one or more communication metrics include the first communication metric. For example, 906 may be performed by the obtaining component 1040.

At 908, the network entity may calculate, based on the first communication metric, a channel quality associated with each CBG, wherein the hierarchical ranking of each CBG is based on a channel quality of each CBG relative to other CBGs of the plurality of CBGs. For example, 908 may be performed by a calculating component 1044.

At 910, the network entity may generate a hierarchical ranking of each codeblock group (CBG) of a plurality of CBGs, wherein the hierarchical ranking is based on a first communication metric associated with a channel via which the plurality of CBGs are used to communicate data. For example, 910 may be performed by a generating component 1046.

At 912, the network entity may output data for transmission via the plurality of CBGs. For example, 912 may be performed by the outputting component 1042.

At 914, the network entity may obtain, from a wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking. For example, 914 may be performed by the obtaining component 1040.

At 916, the network entity may output a re-transmission of the portion of the data previously transmitted via the single CBG and each of the one or more other CBGs having a rank lower than the first ranking. For example, 916 may be performed by the outputting component 1042.

At 918, the network entity may obtain, after the report is outputted, an indication of an updated autocovariance noise matrix (Rₙₙ) associated with the channel. For example, 918 may be performed by obtaining component 918.

Finally, at 920, the network entity may obtain, after the report is outputted, an indication of an end of the wireless node outputting reports identifying a single CBG of the plurality of CBGs. For example, 920 may be performed by the obtaining component 1040.

In certain aspects, at least one of: the hierarchical ranking of each CBG is further based on a capacity associated with each codeblock (CB) within a given CBG; or the capacity is calculated based the channel quality associated with the channel and an autocovariance noise matrix (Rₙₙ) associated with the channel.

In certain aspects, at least one of: the indication of the autocovariance noise matrix (Rnn) is obtained via a control channel, or the one or more processors, individually or in combination, are further configured to cause the apparatus to output, after outputting the report, a request for an updated autocovariance noise matrix (Rnn) associated with the channel.

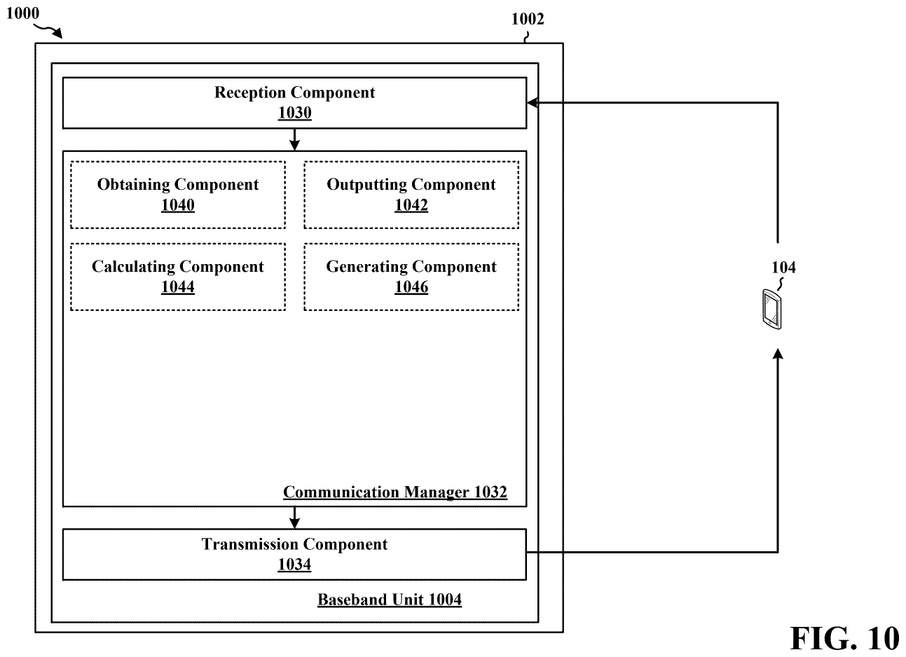

FIG. 10 is a diagram 1000 illustrating an example of a hardware implementation for an apparatus 1002. The apparatus 1002 is a BS and includes a baseband unit 1004. The baseband unit 1004 may communicate through one or more cellular RF transceivers with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 102/180 and may include the memory 376 and/or at least one of the TX processor 316, the RX processor 370, and the controller/processor 375.

In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an obtaining component 1040 configured to: obtain, prior to generating the hierarchical ranking, an indication of an autocovariance noise matrix (Rₙₙ) associated with the channel; obtain, from the wireless node, an indication of one or more communication metrics, wherein at least one of: the channel quality associated with each CBG is based on the one or more communication metrics, the indication of the one or more communication metrics is configured to indicate that the wireless node is capable of generating the report, or the one or more communication metrics include the first communication metric; obtain, from a wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking; obtain, after the report is outputted, an indication of an updated autocovariance noise matrix (Rₙₙ) associated with the channel; and obtain, after the report is outputted, an indication of an end of the wireless node outputting reports identifying a single CBG of the plurality of CBGs; e.g., as described in connection with 902, 906, 914, 918, and 920.

The communication manager 1032 further includes an outputting component 1042 configured to: output a request for information indicative of whether the wireless node is capable of generating the report; output data for transmission via the plurality of CBGs; and output a re-transmission of the portion of the data previously transmitted via the single CBG and each of the one or more other CBGs having a rank lower than the first ranking; e.g., as described in connection with 904, 912, and 916.

The communication manager 1032 further includes a calculating component 1044 configured to: calculate, based on the first communication metric, a channel quality associated with each CBG, wherein the hierarchical ranking of each CBG is based on a channel quality of each CBG relative to other CBGs of the plurality of CBGs; e.g., as described in connection with 908.

The communication manager 1032 further includes a generating component 1046 configured to: generate a hierarchical ranking of each codeblock group (CBG) of a plurality of CBGs, wherein the hierarchical ranking is based on a first communication metric associated with a channel via which the plurality of CBGs are used to communicate data; e.g., as described in connection with 910.

The apparatus may include additional components that perform each of the blocks of the algorithm in the aforementioned call-flow diagram of FIG. 6 and the flowchart of FIG. 9. As such, each block in the aforementioned figures may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes: means for obtaining, prior to generating the hierarchical ranking, an indication of an autocovariance noise matrix (Rₙₙ) associated with the channel; means for outputting a request for information indicative of whether the wireless node is capable of generating the report; means for obtaining, from the wireless node, an indication of one or more communication metrics, wherein at least one of: the channel quality associated with each CBG is based on the one or more communication metrics, the indication of the one or more communication metrics is configured to indicate that the wireless node is capable of generating the report, or the one or more communication metrics include the first communication metric; means for calculating, based on the first communication metric, a channel quality associated with each CBG, wherein the hierarchical ranking of each CBG is based on a channel quality of each CBG relative to other CBGs of the plurality of CBGs; means for generating a hierarchical ranking of each codeblock group (CBG) of a plurality of CBGs, wherein the hierarchical ranking is based on a first communication metric associated with a channel via which the plurality of CBGs are used to communicate data; means for outputting data for transmission via the plurality of CBGs; means for obtaining, from a wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking; means for outputting a re-transmission of the portion of the data previously transmitted via the single CBG and each of the one or more other CBGs having a rank lower than the first ranking; means for obtaining, after the report is outputted, an indication of an updated autocovariance noise matrix (Rₙₙ) associated with the channel; and means for obtaining, after the report is outputted, an indication of an end of the wireless node outputting reports identifying a single CBG of the plurality of CBGs.

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or antenna(s) 320 of the network entity 102/180 illustrated in FIG. 3. Means for transmitting or means for outputting may include a transmitter such as the transmit processor 316 or antenna(s) 320 of the network entity 102/180 illustrated in FIG. 3. Means for calculating, means for generating, means for selecting, means for detecting, and means for determining may include a processing system, which may include one or more processors, such as the controller/processor 375, the memory 376, and/or any other suitable hardware components of the network entity 102/180 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### EXAMPLE ASPECTS

The following examples are illustrative only and may be combined with aspects of other embodiments or teachings described herein, without limitation.

Example 1 is a method for wireless communication at a wireless node, comprising: generating a hierarchical ranking of each codeblock group (CBG) of a plurality of CBGs, wherein the hierarchical ranking is based on a first communication metric associated with a channel via which the plurality of CBGs are used to communicate data; obtaining data via the plurality of CBGs; and outputting a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking.

Example 2 is the method of Example 1, further comprising: obtaining a re-transmission of the portion of the data previously transmitted via the single CBG and each of the one or more other CBGs having a rank lower than the first ranking.

Example 3 is the method of any of Examples 1 and 2, wherein at least one of: the hierarchical ranking of each CBG is based on a channel quality of each CBG relative to channel qualities of other CBGs of the plurality of CBGs, or the channel quality of each CBG is based on the first communication metric.

Example 4 is the method of Example 3, wherein at least one of: the hierarchical ranking of each CBG is further based on a capacity associated with each codeblock (CB) within a given CBG, or the capacity is based on at least one of the channel quality associated with the channel or an autocovariance noise matrix (Rₙₙ) associated with the channel.

Example 5 is the method of any of Examples 3 and 4, further comprising: obtaining a request for information indicative of whether the apparatus is capable of generating the report; and outputting an indication of one or more communication metrics, wherein at least one of: the channel quality associated with each CBG is based on the one or more communication metrics, the indication of the one or more communication metrics is configured to indicate that the apparatus is capable of generating the report, or the one or more communication metrics include the first communication metric.

Example 6 is the method of any of Examples 1-5, further comprising: outputting, prior to generating the hierarchical ranking, an indication of an autocovariance noise matrix (Rₙₙ) associated with the channel.

Example 7 is the method of Example 6, wherein at least one of: the indication of the autocovariance noise matrix (Rₙₙ) is output for transmission via a control channel, or the method further comprising obtaining, after outputting the report, a request for an updated autocovariance noise matrix (Rₙₙ) associated with the channel.

Example 8 is the method of any of Examples 1-7, further comprising: outputting, after outputting the report, an indication of an updated autocovariance noise matrix (Rₙₙ) associated with the channel; or outputting, after the report is outputted, an indication of an end of the apparatus outputting reports identifying a single CBG of the plurality of CBGs.

Example 9 is the method of Example 8, wherein the indication of the updated autocovariance noise matrix (Rₙₙ) is output for transmission on a periodic basis or a semi-persistent basis.

Example 10 is a method for wireless communication at a first wireless node, comprising: generating a hierarchical ranking of each codeblock group (CBG) of a plurality of CBGs, wherein the hierarchical ranking is based on a first communication metric associated with a channel via which the plurality of CBGs are used to communicate data; outputting data for transmission via the plurality of CBGs; and obtaining, from a second wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking.

Example 11 is the method of Example 10, further comprising: outputting a re-transmission of the portion of the data previously transmitted via the single CBG and each of the one or more other CBGs having a rank lower than the first ranking.

Example 12 is the method of any of Examples 10 and 11, further comprising: calculating, based on the first communication metric, a channel quality associated with each CBG, wherein the hierarchical ranking of each CBG is based on a channel quality of each CBG relative to other CBGs of the plurality of CBGs.

Example 13 is the method of Example 12, wherein at least one of: the hierarchical ranking of each CBG is further based on a capacity associated with each codeblock (CB) within a given CBG; or the capacity is calculated based the channel quality associated with the channel and an autocovariance noise matrix (Rₙₙ) associated with the channel.

Example 14 is the method of any of Examples 12 and 13, further comprising: outputting a request for information indicative of whether the second wireless node is capable of generating the report; and obtaining, from the second wireless node, an indication of one or more communication metrics, wherein at least one of: the channel quality associated with each CBG is based on the one or more communication metrics, the indication of the one or more communication metrics is configured to indicate that the second wireless node is capable of generating the report, or the one or more communication metrics include the first communication metric.

Example 15 is the method of any of Examples 10-14, further comprising: obtaining, prior to generating the hierarchical ranking, an indication of an autocovariance noise matrix (Rₙₙ) associated with the channel.

Example 16 is the method of Example 15, wherein at least one of: the indication of the autocovariance noise matrix (Rₙₙ) is obtained via a control channel, or the method further comprising outputting, after outputting the report, a request for an updated autocovariance noise matrix (Rₙₙ) associated with the channel.

Example 17 is the method of any of Examples 10-16, further comprising: obtaining, after the report is outputted, an indication of an updated autocovariance noise matrix (Rₙₙ) associated with the channel; or obtaining, after the report is outputted, an indication of an end of the second wireless node outputting reports identifying a single CBG of the plurality of CBGs.

Example 18 is an apparatus for wireless communications, comprising means for performing a method in accordance with any one of examples 1-9.

Example 19 is an apparatus for wireless communications, comprising means for performing a method in accordance with any one of examples 10-17.

Example 20 is a non-transitory computer-readable medium comprising instructions that, when executed by a wireless node, cause the wireless node to perform a method in accordance with any one of examples 1-9.

Example 21 is a non-transitory computer-readable medium comprising instructions that, when executed by a wireless node, cause the wireless node to perform a method in accordance with any one of examples 10-17.

Example 22 is an apparatus for wireless communications, comprising: one or more memories, individually or in combination, having instructions; and one or more processors, individually or in combination, configured to execute the instructions to cause the apparatus to perform a method in accordance with any one of examples 1-9.

Example 23 is an apparatus for wireless communications, comprising: one or more memories, individually or in combination, having instructions; and one or more processors, individually or in combination, configured to execute the instructions to cause the apparatus to perform a method in accordance with any one of examples 10-17.

Example 24 is a wireless node (e.g., user equipment (UE)), comprising: one or more transceivers; one or more memories, individually or in combination, having instructions; and one or more processors, individually or in combination, configured to execute the instructions to cause the wireless node to perform a method in accordance with any one of examples 1-9, wherein the one or more transceivers are configured to: receive data via the plurality of CBGs; and transmit the report.

Example 25 is a wireless node (e.g., network entity), comprising: one or more transceivers; one or more memories, individually or in combination, having instructions; and one or more processors, individually or in combination, configured to execute the instructions to cause the wireless node to perform a method in accordance with any one of examples 10-17, wherein the one or more transceivers are configured to: transmit data via the plurality of CBGs; and receive the report.

What is claimed is:

1. An apparatus for wireless communication, comprising:
one or more memories, individually or in combination, having instructions; and
one or more processors, individually or in combination, configured to execute the instructions and cause the apparatus to:
generate a hierarchical ranking of each codeblock group (CBG) of a plurality of CBGs, wherein the hierarchical ranking is based on a first communication metric associated with a channel via which the plurality of CBGs are used to communicate data;
obtain data via the plurality of CBGs; and
output a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking.

2. The apparatus of claim 1, wherein the one or more processors, individually or in combination, are further configured to cause the apparatus to:
obtain a re-transmission of the portion of the data previously transmitted via the single CBG and each of the one or more other CBGs having a rank lower than the first ranking.

3. The apparatus of claim 1, wherein at least one of:
the hierarchical ranking of each CBG is based on a channel quality of each CBG relative to channel qualities of other CBGs of the plurality of CBGs, or
the channel quality of each CBG is based on the first communication metric.

4. The apparatus of claim 3, wherein at least one of:
the hierarchical ranking of each CBG is further based on a capacity associated with each codeblock (CB) within a given CBG, or
the capacity is based on at least one of the channel quality associated with the channel or an autocovariance noise matrix (Rₙₙ) associated with the channel.

5. The apparatus of claim 3, wherein the one or more processors, individually or in combination, are further configured to cause the apparatus to:
obtain a request for information indicative of whether the apparatus is capable of generating the report; and
output an indication of one or more communication metrics, wherein at least one of:
the channel quality associated with each CBG is based on the one or more communication metrics;
the indication of the one or more communication metrics is configured to indicate that the apparatus is capable of generating the report; or
the one or more communication metrics include the first communication metric.

6. The apparatus of claim 1, wherein the one or more processors, individually or in combination, are further configured to cause the apparatus to:
output, prior to generating the hierarchical ranking, an indication of an autocovariance noise matrix (Rₙₙ) associated with the channel.

7. The apparatus of claim 6, wherein at least one of:
the indication of the autocovariance noise matrix (Rₙₙ) is output for transmission via a control channel, or
the one or more processors, individually or in combination, are further configured to cause the apparatus to obtain, after outputting the report, a request for an updated autocovariance noise matrix (Rₙₙ) associated with the channel.

8. The apparatus of claim 1, wherein the one or more processors, individually or in combination, are further configured to cause the apparatus to, at least one of:
output, after outputting the report, an indication of an updated autocovariance noise matrix (Rₙₙ) associated with the channel; or
output, after the report is outputted, an indication of an end of the apparatus outputting reports identifying a single CBG of the plurality of CBGs.

9. The apparatus of claim 8, wherein the indication of the updated autocovariance noise matrix (Rₙₙ) is output for transmission on a periodic basis or a semi-persistent basis.

10. The apparatus of claim 1, further comprising one or more transceivers configured to:
receive the data; and
transmit the report, wherein the apparatus is configured as a user equipment (UE).

11. An apparatus for wireless communication, comprising:
one or more memories, individually or in combination, having instructions; and
one or more processors, individually or in combination, configured to execute the instructions and cause the apparatus to:
generate a hierarchical ranking of each codeblock group (CBG) of a plurality of CBGs, wherein the hierarchical ranking is based on a first communication metric associated with a channel via which the plurality of CBGs are used to communicate data;
output data for transmission via the plurality of CBGs; and
obtain, from a wireless node, a report identifying a single CBG of the plurality of CBGs, wherein the single CBG is associated with a first ranking, and wherein the report is configured to request a retransmission of a portion of the data transmitted via: (i) the single CBG, and (ii) each of one or more other CBGs having a rank lower than the first ranking.

12. The apparatus of claim 11, wherein the one or more processors, individually or in combination, are further configured to cause the apparatus to:
output a re-transmission of the portion of the data previously transmitted via the single CBG and each of the one or more other CBGs having a rank lower than the first ranking.

13. The apparatus of claim 11, wherein the one or more processors, individually or in combination, are further configured to cause the apparatus to:
calculate, based on the first communication metric, a channel quality associated with each CBG, wherein the hierarchical ranking of each CBG is based on a channel quality of each CBG relative to other CBGs of the plurality of CBGs.

14. The apparatus of claim 13, wherein at least one of:
the hierarchical ranking of each CBG is further based on a capacity associated with each codeblock (CB) within a given CBG; or
the capacity is calculated based the channel quality associated with the channel and an autocovariance noise matrix (Rₙₙ) associated with the channel.

15. The apparatus of claim 13, wherein the one or more processors, individually or in combination, are further configured to cause the apparatus to:
output a request for information indicative of whether the wireless node is capable of generating the report; and
obtain, from the wireless node, an indication of one or more communication metrics, wherein at least one of:
the channel quality associated with each CBG is based on the one or more communication metrics,
the indication of the one or more communication metrics is configured to indicate that the wireless node is capable of generating the report, or
the one or more communication metrics include the first communication metric.

16. The apparatus of claim 11, wherein the one or more processors, individually or in combination, are further configured to cause the apparatus to:
obtain, prior to generating the hierarchical ranking, an indication of an autocovariance noise matrix (Rₙₙ) associated with the channel.

17. The apparatus of claim 16, wherein at least one of:
the indication of the autocovariance noise matrix (Rₙₙ) is obtained via a control channel, or
the one or more processors, individually or in combination, are further configured to cause the apparatus to output, after outputting the report, a request for an updated autocovariance noise matrix (Rₙₙ) associated with the channel.

18. The apparatus of claim 11, wherein the one or more processors, individually or in combination, are further configured to cause the apparatus to, at least one of:
obtain, after the report is outputted, an indication of an updated autocovariance noise matrix (Rₙₙ) associated with the channel; or
obtain, after the report is outputted, an indication of an end of the wireless node outputting reports identifying a single CBG of the plurality of CBGs.

19. The apparatus of claim 11, further comprising one or more transceivers configured to:
transmit the data; and
receive the report, wherein the apparatus is configured as a network entity.

20. A method for wireless communications at a wireless node, comprising:
generating a hierarchical ranking of each codeblock group (CBG) of a plurality of CBGs, wherein the hierarchical ranking is based on a first communication metric associated with a channel via which the plurality of CBGs are used to communicate data;
obtaining data via the plurality of CBGs; and
outputting a report identifying a single CBG of the plurality of CBGs, wherein the single CBG is associated with a first ranking, and wherein the report is configured to request a retransmission of a portion of the data obtained via: (i) the single CBG, and (ii) each of one or more other CBGs having a rank lower than the first ranking.
